(19) United States
(12) Patent Application Publication
(10) Pub. No.: US 2022/0081580 A1
(43) Pub. Date: Mar. 17, 2022

(54) DYE SUBLIMATION INKJET INK

(71) Applicant: Hewlett-Packard Development Company, L.P., Spring, TX (US)

(72) Inventors: Kai-Kong Iu, San Diego, CA (US); Ronald A. Askeland, San Diego, CA (US); Zhang-Lin Zhou, San Diego, CA (US)

(73) Assignee: Hewlett-Packard Development Company, L.P., Spring (US)

(21) Appl. No.: 17/417,186

(22) PCT Filed: Feb. 4, 2019
(86) PCT No.: PCT/US2019/016485

§ 371 Date: Jun. 22, 2021

(51) Int. Cl. C09D 11/328; C09D 11/40; C09D 11/037; C09D 11/033; C09D 11/102; D06P 5/28; D06P 5/30; D06P 5/20; B41M 5/00; B41M 5/382

(52) U.S. Cl. CPC C09D 11/328; C09D 11/40; C09D 11/037; C09D 11/033; B41M 5/382; D06P 5/004; D06P 5/30; D06P 5/2005; B41M 5/0023; C09D 11/102

(57) ABSTRACT

An example of a dye sublimation inkjet ink includes a disperse dye colorant dispersion; a water soluble polymeric ultraviolet (UV) absorber; a co-solvent; and a balance of water. The water soluble polymeric UV absorber of the dye sublimation inkjet ink has absorption at a radiation wavelength ranging from about 360 nm to about 410 nm.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers, and in particular piezoelectric inkjet printers, are gaining rapid acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating two examples of a printing method; and

FIG. 2 depicts black and white reproductions of originally colored photographs of example and comparative prints on polyester after dye sublimation with different energy exposures.

### DETAILED DESCRIPTION

The textile market is a major industry, and printing on textiles, such as cotton, polyester, etc., may be performed using dye sublimation. Some dye sublimation printing techniques involve thermal transfer, where the dye sublimation ink is first printed onto a transfer medium. The printed transfer medium is then pressed against the desired textile and is heated (e.g., using a heated calendering roller), which transfers the dye from the transfer paper to the textile. The heat sublimates the dye, allowing the dye to migrate into the fibers of the textile. While this process may render printed textiles with desired color attributes and durability performance, the thermal transfer portion of the process can be economically and/or energy inefficient, can reduce print-job thru-put, and can increase the complexity of the overall printing process.

In contrast, the examples disclosed herein do not involve a thermal transfer process. Rather, in the examples disclosed herein, a dye sublimation inkjet ink can be directly printed onto the textile or onto another suitable substrate. The printed ink is exposed to radiation having a wavelength ranging from about 360 nm to about 410 nm, resulting in rapid and localized heat generation within the textile fibers to drive colorant sublimation. Some examples of the dye sublimation inkjet ink include a water soluble polymeric ultraviolet (UV) absorber to enhance the absorption of the applied radiation. Other examples of the dye sublimation inkjet ink include a colorant that effectively absorbs the applied radiation (without the water soluble polymeric UV absorber). The examples disclosed herein render printed textiles or other printed substrates with desired color attributes and durability performance, while also providing a simpler and efficient dye sublimation printing technique that does not involve a transfer medium, a heated calendering roller, etc.

Throughout this disclosure, a weight percentage that is referred to as “wt % active” refers to the loading of an active component of a dispersion or other formulation that is present in the dye sublimation inkjet ink. For example, the disperse dye may be present in a water-based formulation (e.g., a dispersion) before being incorporated into the inkjet ink. In this example, the wt % actives of the dye accounts for the loading (as a weight percent) of the dye that is present in the inkjet ink composition, and does not account for the weight of the other components (e.g., water, etc.) that are present in the formulation with the dye. The term “wt %,” without the term actives, refers to either i) the loading (in the inkjet ink or other composition) of a 100% active component that does not include other non-active components therein, or ii) the loading (in the inkjet ink or another composition) of a material or component that is used “as is” and thus the wt % accounts for both active and non-active components.

Dye Sublimation Inkjet Inks

The dye sublimation inkjet inks disclosed herein exhibit light absorption efficiency at the wavelength(s) used for dye sublimation.

In some examples, the dye sublimation inkjet ink includes a water soluble polymeric UV absorber that enhances absorption of the dye sublimation radiation. An example of this ink comprises a disperse dye colorant dispersion; a water soluble polymeric UV absorber having absorption at a radiation wavelength ranging from about 360 nm to about 410 nm; a co-solvent; and a balance of water. In some examples, the dye sublimation inkjet ink consists of these components, and thus does not include any other components. In other examples, the dye sublimation inkjet ink may include other additives, such as a surfactant, a chelating agent, a buffer, an antimicrobial agent, and combinations thereof.

In other examples, the ink includes a colorant (disperse dye) that effectively absorbs the dye sublimation radiation, and thus, the water soluble polymeric UV absorber is not included in the ink composition. An example of this ink includes of a disperse dye colorant dispersion including a disperse dye having absorption at the radiation wavelength ranging from about 360 nm to about 410 nm; a co-solvent; and a balance of water. This example inks does not include the water soluble polymeric UV absorber. Another example of this ink consists of a disperse dye colorant dispersion; optionally, an additive selected from the group consisting of a surfactant, a chelating agent, a buffer, an antimicrobial agent, and combinations thereof; a co-solvent; and a balance of water.

The composition of the dye sublimation inkjet ink depends, in part, upon the molecular structure of the dye in the ink, and whether the dye sufficiently absorbs the wavelength of light used for dye sublimation. Examples of the different dye sublimation inkjet inks disclosed herein will now be described in more detail.

Example Inks with the Water Soluble Polymeric UV Absorber

As mentioned, some examples of the dye sublimation inkjet ink disclosed herein include the disperse dye colorant dispersion; the water soluble polymeric having absorption at a radiation wavelength ranging from about 360 nm to about 410 nm; the co-solvent; and the balance of water.

Each disperse dye colorant dispersion includes a disperse dye, a dispersant, and a dispersion vehicle. In examples of the dye sublimation inkjet ink that include the water soluble polymeric UV absorber, it is to be understood that the disperse dye in the disperse dye colorant dispersion may not absorb enough of the radiation (e.g., having a wavelength ranging from about 360 nm to about 410 nm) to undergo sublimation. In an example, the absorption/absorbance exhibited by this type of disperse dye at the desirable wavelength may be less than 0.2 (where absorbance (A) is calculated by A=εcL, in which ε is the molar extinction coefficient and is >1000 M⁻¹cm⁻¹, c is the molar concentration, and L is the light path length in cm). While these disperse dyes may be any color, it has been found that cyan disperse dyes and magenta disperse dyes may be particularly suitable for use with the water soluble polymeric UV absorber. As such, in some examples, the disperse dye colorant dispersion is a cyan disperse dye colorant dispersion or a magenta disperse dye colorant dispersion. As specific examples, cyan disperse dyes (in the cyan disperse dye colorant dispersion) may include blue disperse dyes, such as disperse blue 27, disperse blue 60, disperse blue 73, disperse blue 77, disperse blue 87, disperse blue 257, disperse blue 291:1, disperse blue 359, disperse blue 360, disperse blue 367, and mixtures thereof; and magenta disperse dyes (in the magenta disperse dye colorant dispersion) may include red disperse dyes, such as disperse red 60, disperse red 82, disperse red 86, disperse red 86:1, disperse red 167:1, disperse red 279, and mixtures thereof.

The disperse dye colorant dispersion may include from about 10 wt % dye solids to about 20 wt % dye solids based on the total weight of the colorant dispersion.

As mentioned, each disperse dye colorant dispersion also includes a dispersant. The dispersant may be any suitable polymeric dispersant that can disperse the dye and that can be jetted via a thermal or piezoelectric inkjet printhead.

Some examples of the polymeric dispersant include polymers or copolymers of acrylics, methacrylics, acrylates, methacrylates, styrene, substituted styrene, α-methylstyrene, substituted α-methyl styrenes, vinyl naphthalenes, vinyl pyrrolidones, maleic anhydride, vinyl ethers, vinyl alcohols, vinyl alkyls, vinyl esters, vinyl ester/ethylene copolymers, acrylamides, and/or methacrylamides. Some specific examples include a styrene methacrylic acid copolymer, a styrene acrylic acid copolymer, styrene acrylic acid-acrylic ester copolymers, styrene methacrylic acid-acrylic ester copolymers, a styrene maleic anhydride copolymer, polyacrylic acid partial alkyl ester, polyalkylene polyamine, polyacrylates, and vinyl naphthalene-maleic acid copolymers. Another example of a suitable polymeric dispersant is a polyurethane polymer. Still other examples of suitable polymeric dispersants for the disperse dye colorant dispersion include block acrylic copolymers, including A-B block copolymers such as benzyl methacrylate-methacrylic acid diblock copolymers and butyl methacrylate-methacrylic acid diblock copolymers. Still further examples of suitable polymeric dispersants include ABC triblock copolymers, such as benzyl methacrylate-methacrylic acid-ethoxytriethyleneglycol methacrylate triblock copolymers and butyl methacrylate-methacrylic acid-ethoxytriethyleneglycol methacrylate triblock copolymers. Still some other examples of suitable dispersants include low acid value acrylic resins, such as JONCRYL® 586, 671, 675, 678, 680, 683, 690, 693, and 695 (from BASF Corp.).

Examples of polymerization methods used to form the dispersant may include free radical processes, Group Transfer Processes (GTP), radical addition fragmentation (RAFT), atom transfer reaction (ATR), special chain transfer polymerization technology (SCT), and the like. As one example, the dispersant may be a graft acrylic copolymer made by SCT.

In other examples, the disperse dyes may be self-dispersing dyes. The disperse dyes may be exposed to a diazonium treatment (where a charged free radical from a degraded azo attaches to the colorant), or to an ozone treatment (oxidation and functionalization with, e.g., a carboxylic acid), or to a crosslinking treatment to render the dye self-dispersing.

The disperse dye colorant dispersion may include from about 4 wt % dispersant solids to about 7 wt % dispersant solids, based on the total weight of the colorant dispersion.

The mean particle size of the solids (e.g., the disperse dyes and the dispersants) in the disperse dye colorant dispersion may range from about 50 nm to about 100 nm. In another example, the mean particle size of the disperse dye ranges from about 100 nm to about 200 nm. These particle sizes (which may be volume-weighted mean diameters) are particularly suitable for being jetted through the orifices of thermal or piezo inkjet printheads.

The dispersion vehicle may include water and a water soluble or water miscible co-solvent. Examples of the water soluble or water miscible co-solvent in the disperse dye colorant dispersion may include alcohols (e.g., diols, such as 1,2-propanediol, 1,3-propanediol, etc.), ketones, ketoalcohols, ethers (e.g., the cyclic ether tetrahydrofuran (THF), and others, such as thiodiglycol, sulfolane, 2-pyrrolidone, 1-(2-hydroxyethyl-2-pyrrolidone, 1,3-dimethyl-2-imidazolidinone and caprolactam; glycols such as ethylene glycol, diethylene glycol, tritriethylene glycol, tetraethylene glycol, propylene glycol, dipropylene glycol, tripropylene glycol, trimethylene glycol, butylene glycol, and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, and diethylene glycol monoethyl ether; and lower dialkyl ethers of polyhydric alcohols, such as diethylene glycol dimethyl or diethyl ether.

One or more of these co-solvents may be present in the disperse dye colorant dispersion in respective amounts ranging from about 1 wt % to about 5 wt %, based on the total weight of the colorant dispersion. The balance of the disperse dye colorant dispersion is water, such as purified water or deionized water.

In an example, the disperse dye colorant dispersion has i) a mean particle size ranging from about 50 nm to about 200 nm, and ii) from about 10 wt % dye solids to about 20 wt % dye solids and from about 4 wt % to about 7 wt % dispersant solids, based on the total weight of the colorant dispersion. In this example, the remainder of the disperse dye colorant dispersion may be co-solvent(s) and water.

The disperse dye colorant dispersion may be added to the other ink components (e.g., the polymeric UV absorber, the co-solvent, and the balance of water) such that the disperse dye colorant dispersion is present in an amount ranging from about 1 wt % actives to about 15 wt % actives, based on a total weight of the dye sublimation inkjet ink. In another example, the disperse dye colorant dispersion may be present in an amount ranging from about 3 wt % actives to about 10 wt % actives, based on the total weight of the dye sublimation inkjet ink. The wt % actives of the disperse dye colorant dispersion accounts for the loading (as a weight percent) of the active dye solids present in the ink, and does not account for the weight of the other components (e.g., co-solvent, water, etc.) of the disperse dye colorant dispersion in the inkjet ink.

These examples of the dye sublimation inkjet ink also include the polymeric UV absorber. The polymeric UV absorber may be any polymeric UV absorber that is (i) water soluble, (ii) has absorbance at the radiation wavelength ranging from about 360 nm to about 410 nm, and (iii) has a high molecular weight so that the UV absorber is not sublimed during the dye sublimation process.

In one example, the polymeric UV absorber can have a water solubility of at least 0.1 wt %. When the water solubility is at least 0.1 wt %, it means that of the total wt % of the polymeric UV absorber added to water, at least 0.1 wt % of the total is water soluble. In some instances, the polymeric UV absorber may have a water solubility ranging from 0.1 wt % to 20 wt %. It is believed that higher water solubility, potentially up to 100 wt %, may also be achieved.

The polymeric UV absorber has absorbance at the radiation wavelength ranging from about 360 nm to about 410 nm. The phrase “having absorption” or “has absorbance”, when used in combination with the polymeric UV absorber, means that at least 5% of radiation having wavelengths within the specified range is absorbed by the polymeric UV absorber.

The polymeric UV absorber also has a high molecular weight so that it does not volatize during the dye sublimation process. As such, the UV absorber does not evaporate, but remains at the surface of the fibers. This property of the UV absorber may be particularly desirable when multiple energy exposure events are used to achieve sublimation because the UV absorber remains in contact with the substrate and can continuously transfer heat (during radiation exposure events) for dye sublimation. In an example, the high molecular weight of the polymeric UV absorber ranges from about 500 g/mol to about 30,000 g/mol. In an example, the high molecular weight is about 750 g/mol.

The polymeric UV absorber is essentially colorless. By “essentially colorless”, it is meant that the polymeric UV absorber has no color (e.g., is clear) or has a slight tint (e.g., yellow). The lower the UV wavelength of absorption, the less of the color of the polymeric UV absorber that will be imparted to the substrate.

In some of the examples disclosed herein, the water soluble polymeric UV absorber includes a functionalized aromatic chromophore moiety, a polyether chain, and an amide linkage or an ether linkage attaching one end of the polyether chain to the functionalized aromatic chromophore moiety. Each component of these examples of the polymeric UV absorber is discussed in greater detail below.

One portion of some examples of the polymeric UV absorber is the functionalized aromatic chromophore moiety. This moiety has absorbance at the radiation wavelength ranging from about 360 nm to about 410 nm. In some examples, the functionalized aromatic chromophore moiety of the water soluble polymeric UV absorber includes 3 to 4 conjugate rings and is selected from the group consisting of an anthrone moiety, an anthracene moiety, a phenanthrene moiety, a chrysene moiety, a pyrene moiety, a perylene moiety, a triphenylene moiety, a xanthene moiety, a cyanine moiety, a merocyanine moiety, an acridone moiety, an acridine moiety, an anthraquinone moiety, and a coumarin moiety.

In some examples, the functionalized aromatic chromophore moiety is an anthrone moiety. As used herein, the “anthrone moiety” has the formula:

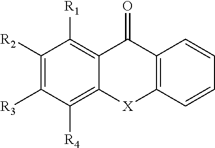

where X can be S, O, or NH. When X═S, the anthrone moiety is thioxanthenone, and when X═O, the anthrone moiety is xanthenone. When X═NH, the anthrone moiety is acridinone. In this example, the functionalized aromatic chromophore moiety is the acridone moiety. When X═CO, the anthrone moiety is anthraquinone. In this example, the functionalized aromatic chromophore moiety is the anthraquinone moiety. R₁, R₂, R₃, and R₄ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group; and R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group.

In other examples, the functionalized aromatic chromophore moiety is an anthracene moiety. As used therein, the “anthracene moiety” has the formula:

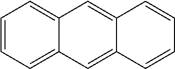 [SMILES: c1ccc2cc3ccccc3cc2c1]

where at least one hydroxyl functional group (—OH) is attached to at least one of the carbons in at least one of the benzene rings.

In still other examples, the functionalized aromatic chromophore moiety is a phenanthrene moiety. As used therein, the “phenanthrene moiety” has the formula:

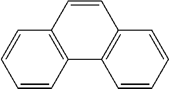 [SMILES: c1ccc2c(c1)ccc1ccccc12]

where at least one hydroxyl functional group (—OH) is attached to at least one of the carbons in at least one of the benzene rings.

In yet other examples, the functionalized aromatic chromophore moiety is a chrysene moiety. As used therein, the “chrysene moiety” has the formula:

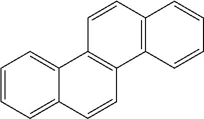 [SMILES: c1ccc2c(c1)ccc1c3ccccc3ccc21]

where at least one hydroxyl functional group (—OH) is attached to at least one of the carbons in at least one of the benzene rings.

In some other examples, the functionalized aromatic chromophore moiety is a pyrene moiety. As used therein, the “pyrene moiety” has the formula:

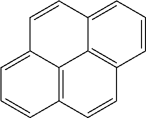 [SMILES: c1cc2ccc3cccc4ccc(c1)c2c34]

where at least one hydroxyl functional group (—OH) is attached to at least one of the carbons in at least one of the benzene rings.

In still some other examples, the functionalized aromatic chromophore moiety is a perylene moiety. As used therein, the “perylene moiety” has the formula:

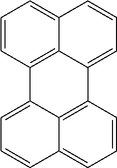 [SMILES: c1cc2cccc3c4cccc5cccc(c(c1)c23)c54]

where at least one hydroxyl functional group (—OH) is attached to at least one of the carbons in at least one of the benzene rings.

In yet some other examples, the functionalized aromatic chromophore moiety is a triphenylene moiety. As used therein, the “triphenylene moiety” has the formula:

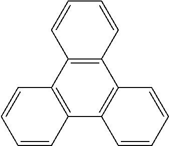 [SMILES: c1ccc2c(c1)c1ccccc1c1ccccc21]

where at least one hydroxyl functional group (—OH) is attached to at least one of the carbons in at least one of the benzene rings.

In other examples, the functionalized aromatic chromophore moiety is an xanthene moiety. As used therein, the “xanthene moiety” has the formula:

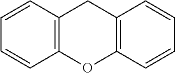 [SMILES: c1ccc2c(c1)Cc1ccccc1O2]

where at least one hydroxyl functional group (—OH) is attached to at least one of the carbons in at least one of the benzene rings.

In still other examples, the functionalized aromatic chromophore moiety is a cyanine moiety. As used therein, the “cyanine moiety” has the formula:

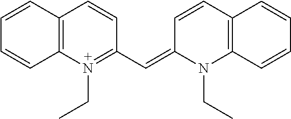

where at least one hydroxyl functional group (—OH) is attached to at least one of the carbons in at least one of the benzene rings.

In yet other examples, the functionalized aromatic chromophore moiety is a merocyanine moiety. As used therein, the “merocyanine moiety” has the formula:

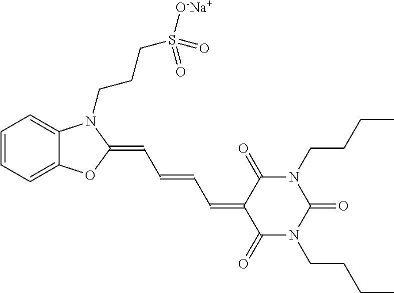

where at least one hydroxyl functional group (—OH) is attached to at least one of the carbons in the benzene ring.

In some other examples, the functionalized aromatic chromophore moiety is an acridine moiety. As used therein, the “acridine moiety” has the formula:

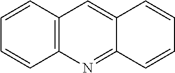 [SMILES: c1ccc2nc3ccccc3cc2c1]

where at least one hydroxyl functional group (—OH) is attached to at least one of the carbons in at least one of the benzene rings.

In still some other examples, the functionalized aromatic chromophore moiety is a coumarin moiety. As used therein, the “coumarin moiety” has the formula:

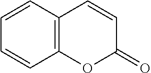 [SMILES: O=c1ccc2ccccc2o1]

where at least one hydroxyl functional group (—OH) is attached to at least one of the carbons in the benzene ring.

The other portion of some examples of the polymeric UV absorber disclosed herein includes polyether chain(s). Suitable examples of the polyether chains include polyethylene glycol or methyl substituted polyethylene glycol. The molecular weight of the polyether chain can, in some cases, affect the solubility of the final polymeric UV absorber. For example, a higher ratio of oxygen atoms to carbon atoms in the polyether chain tends to render the polymeric UV absorber more water soluble. The molecular weight of the polyether chain can also affect the degree to which the polymeric UV absorber can migrate in or from the inkjet ink. Longer polyether chains can make it more difficult for the polymeric UV absorber to move within the dye sublimation inkjet ink, thus keeping the UV absorber in close contact with the disperse dye. As such, the molecular weight and length of the polyether chain can be selected to provide good water solubility and low or no migration of the polymeric UV absorber.

In an example, one end of the polyether chain is attached to the functionalized aromatic chromophore moiety through an amide linkage or an ether linkage. It has been found that the polymeric UV absorber disclosed herein is hydrolytically stable due to the amide or ether linkage, especially when compared to UV absorber s including an ester linkage. As such, the amide or ether linkage improves the stability of the polymeric UV absorber in examples of the dye sublimation inkjet ink.

As used herein, “amide linkage” refers to either an amide group or an amide group with a bridging group (shown in some formulas as “Y”) attached to the carbon atom of the amide group. The amide linkage connects one of the benzene rings of the functionalized aromatic chromophore moiety with the polyether chain. The polyether chain may be directly bonded to the nitrogen atom of the amide group, and the carbon atom of the amide group may either be directly bonded, or linked through the bridging group to a carbon atom in the one benzene ring of the functionalized aromatic chromophore moiety. It is to be understood that the amide linkage may be attached to the functionalized aromatic chromophore moiety at different positions on the one benzene ring. For example, the carbon atom of the amide group, or the carbon atom of the bridging group may be attached to the carbon atom at the ortho position, meta position, or the para position of the ring. The position at which the amide linkage is attached depends, in part, on the starting material used as the functionalized aromatic chromophore moiety when forming the polymeric UV absorber. The amide linkage can be formed by a suitable reaction, such as a substitution reaction or a condensation reaction.

As used herein, “ether linkage” refers to the ether group (i.e., R′—O—R″) that connects one of the benzene rings of the functionalized aromatic chromophore moiety with the polyether chain. R′ and R″ of the ether linkage may be part of the functionalized aromatic chromophore moiety and the polyether chain, respectively. For example, the R′ of the ether linkage may be one of the carbon atoms in the one benzene ring and the R″ of the ether linkage may be the carbon atom at one end of the polyether chain. It is to be understood that the ether linkage may be attached to the functionalized aromatic chromophore moiety at different positions on the one benzene ring. For example, the R′ carbon atom of the ether linkage may be the carbon atom at the ortho position, meta position, or the para position of the ring. The position at which the ether linkage is attached depends, in part, on the starting material used as the functionalized aromatic chromophore moiety when forming the polymeric UV absorber. The ether linkage can be formed by a suitable reaction, such as a substitution reaction.

In some examples, the functionalized aromatic chromophore moiety, polyether chain, and amide or ether linkage do not form the entire polymeric UV absorber. In some examples, the polymeric UV absorber may include additional functionalized aromatic chromophore moieties and/or polyether chains. In some other examples, the polymeric UV absorber may have functional group(s) attached to an opposed end of the polyether chain.

In one example, the water soluble polymeric UV absorber has a formula (I) of:

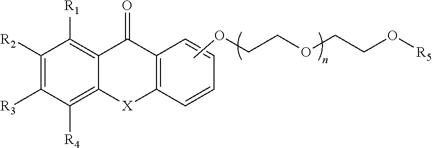

and wherein: R₁, R₂, R₃, R₄, and R₅ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group; R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group; X is O, S, or NH; and n ranges from 1 to 200. Some examples of suitable alkyl groups include methyl, ethyl, propyl, isopropyl, butyl, isobutyl, pentyl, hexyl, etc. One example of a suitable alkene group is an ethylene group. Some examples of suitable aryl groups include phenyl, phenylmethyl, etc. As depicted in formula (I), the linkage is an ether linkage. In one example, the water soluble polymeric UV absorber has the formula (I), wherein R₁-R₄═H; R₅═Me, X═S; and n=11.

In another example, the polymeric UV absorber has a formula (II) of:

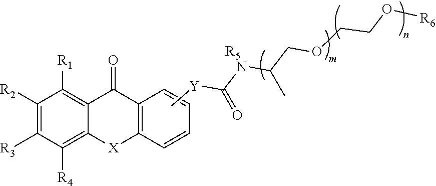

and wherein: R₁, R₂, R₃, R₄, R₅, and R₆ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO₂—R_{d}, —SO₂—O—R_{d}, —SO₂NR_{d}Rₑ and a perfluoroalkyl group; R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group; Y is a bond, (CH₂)_{q}, or O(CH₂)_{q}, wherein q is any integer from 1 to 100; X is O, S, or NH; m ranges from 1 to 200; and n ranges from 1 to 200. Some examples of suitable alkyl groups include methyl, ethyl, propyl, isopropyl, butyl, isobutyl, pentyl, hexyl, etc. One example of a suitable alkene group is an ethylene group. Some examples of suitable aryl groups include phenyl, phenylmethyl, etc. As depicted in formula (II), the linkage is an amide linkage.

In other examples, the dye sublimation inkjet further comprises an additional functionalized aromatic chromophore moiety attached to the opposed end of the polyether chain through an additional ether linkage or an additional amide linkage.

In one example, the polymeric UV absorber has the formula (III) of:

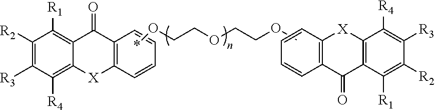

which includes an additional anthrone moiety attached to the opposed end of the polyether chain through the additional ether linkage.

In formula (III), R₁, R₂, R₃, and R₄ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group. R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. As mentioned above, some examples of suitable alkyl groups include methyl, ethyl, propyl, isopropyl, butyl, isobutyl, pentyl, hexyl, etc.; an example of a suitable alkene group is an ethylene group; and some examples of suitable aryl groups include phenyl, phenylmethyl, etc. It is to be understood that these groups may be used in any of the formulas disclosed herein. In formula (III), X is O, S, or NH and the polyether chain has n number of repeating monomer units, where n ranges from 1 to 200.

In another example, the polymeric UV absorber has the formula (IV) of:

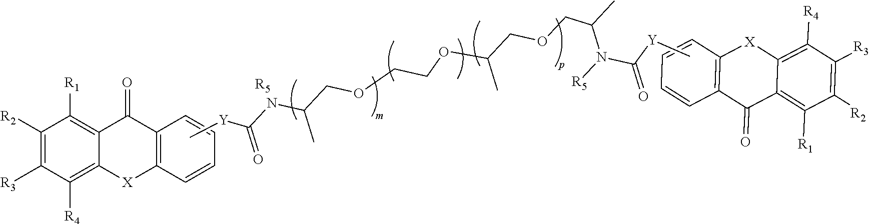

which includes an additional anthrone moiety attached to the opposed end of the polyether chain through the additional amide linkage.

In formula (IV), R₁, R₂, R₃, R₄, and R₅ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group. R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. As mentioned above, some examples of suitable alkyl groups include methyl, ethyl, propyl, isopropyl, butyl, isobutyl, pentyl, hexyl, etc.; an example of a suitable alkene group is an ethylene group; and some examples of suitable aryl groups include phenyl, phenylmethyl, etc. In formula (IV), X is O, S, or NH, Y is a bond, (CH₂)_{q}, or O(CH₂)_{q}, where q is any integer from 1 to 100, the first polyether chain has m number of repeating monomer units, where m ranges from 1 to 200, the second polyether chain has n number of repeating monomer units, where n ranges from 1 to 200, and the third polyether chain has p number of repeating monomer units, where p ranges from 1 to 200.

In yet another example, the polymeric UV absorber includes first, second, and third functionalized aromatic chromophore moieties. Additionally, in this example, the first, second, and third functionalized aromatic chromophore moieties are each individually and respectively attached to first, second, and third amide or ether linkages. The first, second, and third amide or ether linkages are attached to first, second, and third polyether chains, respectively. In an example, the first amide or ether linkage attaches one end of the first polyether chain to the first functionalized aromatic chromophore moiety. The opposed end of the first polyether chain is attached to each of the second and third polyether chains through carbon atom(s).

Two examples of the polymeric UV absorber having three anthrone moieties respectively have the formulas (V, with three ether linkages) and (VI, with three amide linkages):

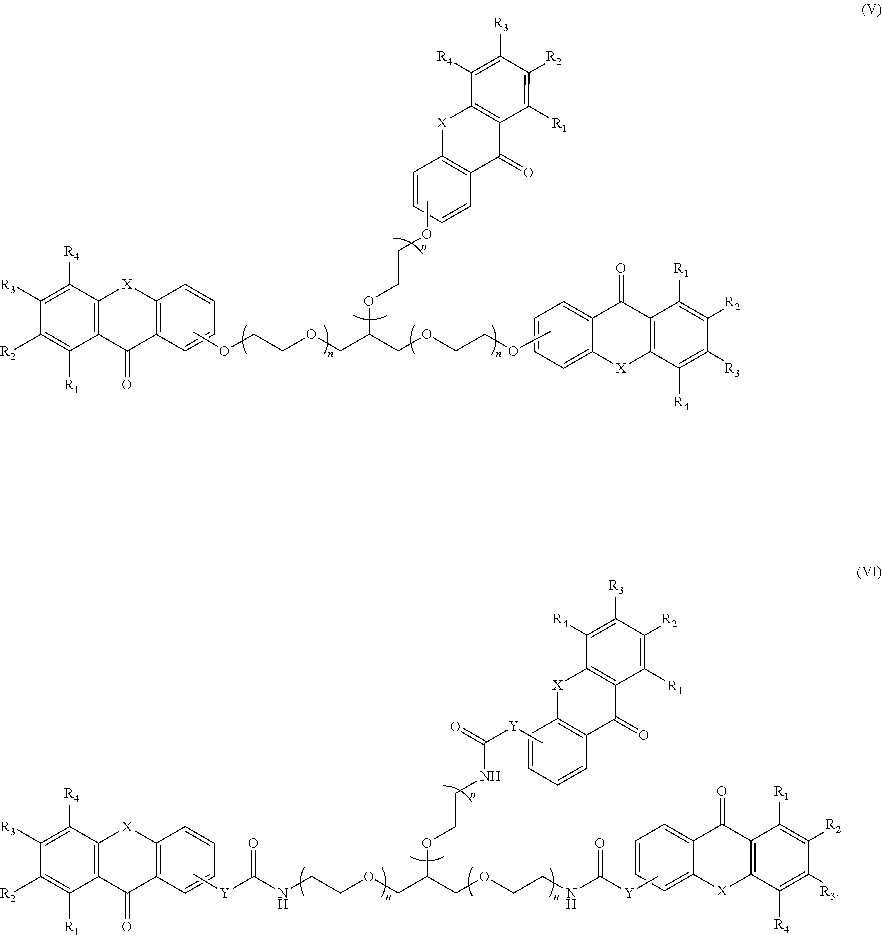

In formulas (V) and (VI), R₁, R₂, R₃ and R₄ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group. R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. As mentioned above, some examples of suitable alkyl groups include methyl, ethyl, propyl, isopropyl, butyl, isobutyl, pentyl, hexyl, etc.; one example of a suitable alkene group is an ethylene group; and some examples of suitable aryl groups include phenyl, phenylmethyl, etc. In each of formulas (V) and (VI), each of the polyether chains has n number of repeating monomer units, where n ranges from 1 to 200, and X is O, S, or NH. In formula (VI), Y is a bond, (CH₂)_{q}, or O(CH₂)_{q}, where q is any integer from 1 to 100.

Still further, in another example, the polymeric UV absorber includes first, second, third, and fourth functionalized aromatic chromophore moieties. In this example, the first, second, third, and fourth functionalized aromatic chromophore moieties are each individually and respectively attached to first, second, third, and fourth amide or ether linkages. The first, second, third, and fourth amide or ether linkages are attached to first, second, third, and fourth polyether chains, respectively. In an example, the first amide or ether linkage attaches one end of the first polyether chain to the first functionalized aromatic chromophore moiety. The opposed end of the first polyether chain is attached to each of the second, third, and fourth polyether chains through carbon atom(s).

Two examples of the polymeric UV absorber having four anthrone moieties respectively have the formulas (VII, with four ether linkages) and (VIII, with four amide linkages):

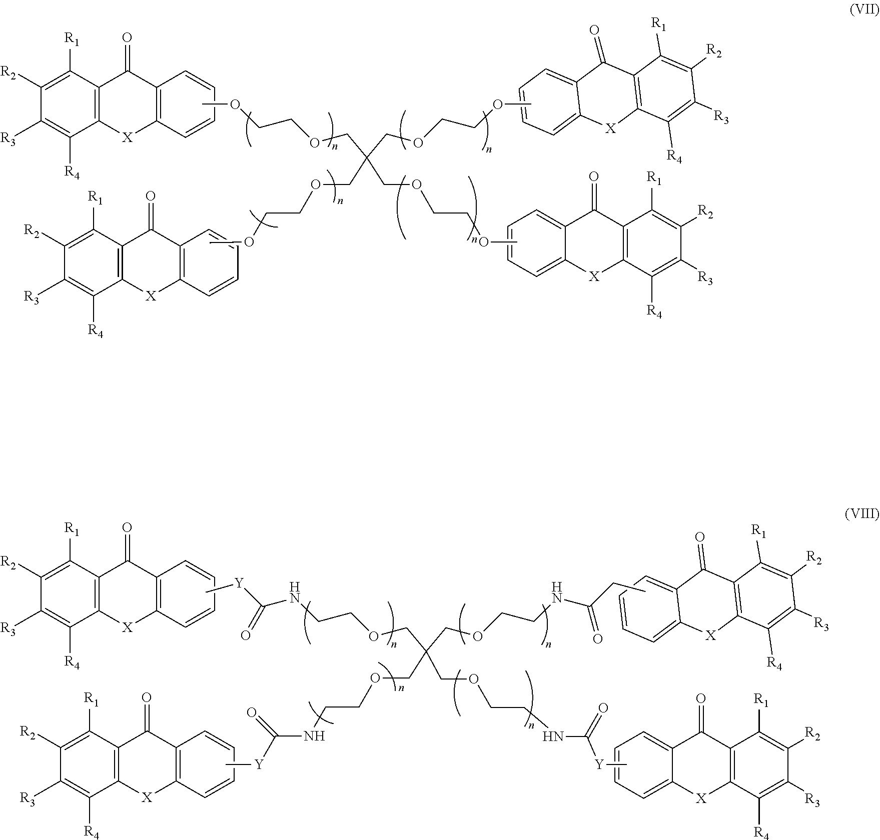

In formulas (VII) and (VIII), R₁, R₂, R₃ and R₄ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group. R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. As mentioned above, some examples of suitable alkyl groups include methyl, ethyl, propyl, isopropyl, butyl, isobutyl, pentyl, hexyl, etc.; one example of a suitable alkene group is an ethylene group; and some examples of suitable aryl groups include phenyl, phenylmethyl, etc. In each of formulas (VII) and (VIII), each of the polyether chains has n number of repeating monomer units, where n ranges from 1 to 200, and X is O, S, or NH. In formula (VIII), Y is a bond, (CH₂)_{q}, or O(CH₂)_{q}, where q is any integer from 1 to 100.

In each of formulas I through VIII, it is noted that the polyether chain(s) may be connected to different positions of the one benzene ring of the anthrone moiety or moieties. In each of formulas I through VIII, it is also noted that different functionalized aromatic chromophore moieties may be used in place of the anthrone moiety or moieties.

In some examples, the water soluble polymeric UV absorber is present in an amount ranging from about 0.1 wt % to about 20 wt % based on a total weight of the dye sublimation inkjet ink. In some examples, the water soluble polymeric UV absorber is present in an amount ranging from about 0.1 wt % to about 10 wt % based on the total weight of the dye sublimation inkjet ink. In one specific example, the water soluble polymeric UV absorber may be present in an amount of about 4 wt % based on a total weight of the dye sublimation inkjet ink. In another example, the water soluble polymeric UV absorber may be present in an amount of about 2.4 wt % based on a total weight of the dye sublimation inkjet ink.

In addition to the disperse dye colorant dispersion and the water soluble polymeric UV absorber, these examples of the dye sublimation inkjet ink also include a co-solvent and a balance of water.

The co-solvent(s) may be present in an amount ranging from about 4 wt % to about 30 wt % (based on the total weight of the thermal inkjet fluid composition). Examples of co-solvents include alcohols, aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like.

Specific examples of alcohols may include ethanol, isopropyl alcohol, butyl alcohol, and benzyl alcohol. The co-solvent may also be a polyhydric alcohol or a polyhydric alcohol derivative. Examples of polyhydric alcohols may include ethylene glycol, diethylene glycol, propylene glycol, dipropylene glycol, butylene glycol, triethylene glycol, 1,5-pentanediol, 1,2-hexanediol, 1,2,6-hexanetriol, 1,2-butanediol, 1,2-propanediol, 1,3-propanediol, glycerin (glycerol), trimethylolpropane, and xylitol. Examples of polyhydric alcohol derivatives may include an ethylene oxide adduct of diglycerin. The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine. Other specific co-solvent examples include tripropylene glycol methyl ether, tripropylene glycol n-butyl ether, 2-ethyl-2-(hydroxymethyl)-1,3-propane diol (EPHD), 2-methyl-1,3-propanediol, dimethyl sulfoxide, and/or sulfolane. In one specific example, the co-solvent includes glycerol. In another specific example, the co-solvent includes glycerol, ethoxylated glycerol, and optionally a water soluble or water miscible organic solvent (the latter of which may be contributed from the disperse dye colorant dispersion). In still another example, the co-solvent includes glycerol, ethoxylated glycerol, 2-methyl-1,3-propanediol, dipropylene glycol, and combinations thereof.

It is to be understood that water is present in addition to the co-solvent(s) and makes up a balance of the ink. As such, the weight percentage of the water present in the dye sublimation inkjet inks will depend, in part, upon the weight percentages of the other components. The water may be purified or deionized water.

Some examples of the dye sublimation inkjet ink that include the polymeric UV absorber may also include one or more additives. Examples of suitable additives include a surfactant, a chelating agent, a buffer, an antimicrobial agent, and combinations thereof.

In an example, the total amount of surfactant(s) in the dye sublimation inkjet ink ranges from about 0 wt % to about 2 wt % (with respect to the weight of the dye sublimation inkjet ink). In another example, the surfactant is present in an amount of 1 wt % or less. The surfactant(s) may be included in the dye sublimation inkjet ink to aid in jettability, control the viscosity, to improve the lubricity, and/or to prevent agglomeration of the dispersed dye solids. Examples of suitable surfactants include oleth-3-phosphate, non-ionic, low foaming surfactants, such as ethoxylated 2,4,7,9-tetramethyl 5 decyn-4,7-diol (commercially available as SURFYNOL® 465 (HLB 13) from Evonik Industries) and other ethoxylated surfactants (commercially available as SURFYNOL® 440 (HLB 8) from Evonik Industries), or secondary alcohol ethoxylates (commercially available as TERGITOL® 15-S-7 (HLB 12.1), TERGITOL® 15-S-9 (HLB 12.6), etc. from The Dow Chemical Co.). In an example, the surfactant is oleth-3-phosphate, ethoxylated 2,4,7,9-tetramethyl 5 decyn-4,7-diol, or combinations thereof.

The chelating agent is another example of an additive that may be included in these examples of the dye sublimation inkjet ink. When included, the chelating agent is present in an amount greater than 0 wt % actives and less than 0.1 wt % actives based on the total weight of the dye sublimation inkjet ink. In an example, the chelating agent is present in an amount ranging from about 0.04 wt % actives to about 0.08 wt % actives based on the total weight of the dye sublimation inkjet ink.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na₃MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

In an example, the pH of the dye sublimation inkjet ink ranges from about 4 to about 10 at the time of manufacture. In another example, the pH of the dye sublimation inkjet ink ranges from about 6.5 to about 8.5 at the time of manufacture. pH adjuster(s), such as a buffer, may be added to the ink to counteract any slight pH drop that may occur over time. The pH may drop from about 0.5 units to about 1 unit over time after being manufactured. As such, the pH of the inks disclosed herein may be lower than the ranges set forth herein, depending, in part, upon how much time has passed since manufacture. In an example, the total amount of buffer(s) in the ink ranges from 0 wt % to about 0.5 wt % (with respect to the weight of the thermal inkjet dye sublimation ink). In another example, the total amount of buffer(s) in the ink is about 0.1 wt % (with respect to the weight of the thermal inkjet dye sublimation ink). Examples of some suitable buffers include TRIS (tris(hydroxymethyl)aminomethane or Trizma), bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of antimicrobial agent(s) in the dye sublimation inkjet ink ranges from about 0 wt % actives to about 0.5 wt % actives (with respect to the weight of the ink). In another example, the total amount of antimicrobial agent(s) in the dye sublimation inkjet ink composition ranges from about 0.001 wt % actives to about 0.1 wt % actives (with respect to the weight of the dye sublimation inkjet ink).

Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

Example Inks without the Water Soluble Polymeric UV Absorber

As mentioned herein, other examples of the dye sublimation inkjet ink disclosed herein consist of a disperse dye colorant dispersion; an additive selected from the group consisting of a surfactant, a chelating agent, a buffer, an antimicrobial agent, and combinations thereof; a co-solvent; and the balance of water.

In examples of the dye sublimation inkjet ink that do not include the water soluble polymeric UV absorber, it is to be understood that the disperse dye in the disperse dye colorant dispersion may absorb enough of the radiation (e.g., having a wavelength ranging from about 360 nm to about 410 nm) to undergo sublimation. In an example, the absorption/absorbance exhibited by this type of disperse dye at the desirable wavelength may be greater than 0.7 (where absorbance (A) is calculated by A=εcL, in which ε is the molar extinction coefficient and is >1000 M⁻¹cm⁻¹, c is the molar concentration, and L is the light path length in cm). While these disperse dyes may be any color, it has been found that black disperse dyes and yellow disperse dyes may be particularly suitable for use without the water soluble polymeric UV absorber. As such, in some examples, the disperse dye colorant dispersion is a black disperse dye colorant dispersion or a yellow disperse dye colorant dispersion.

Black disperse dye colorant dispersions often include a blend of disperse dyes, such as, for example, blends of blue, brown and yellow disperse dyes, or blends of blue, orange and violet disperse dyes, or blends of blue, orange and yellow disperse dyes, or blue, magenta, and yellow dyes. An example of a suitable blue, brown and yellow disperse dye blend include disperse blue 360 (DB360), disperse brown 27, and disperse yellow 54 (DY54). Some examples of suitable blue, orange and violet disperse dye blends include disperse blue 291:1 (DB291:1), disperse orange 29 (D029) and disperse violet 63, or DB291:1, D029 and disperse violet 99. An example of a suitable blue, orange and yellow dye blend includes DB360, disperse orange 25, and DY54. An example of a suitable blue, magenta, and yellow dye blend includes disperse blue 77 (DB77), disperse red 92, and disperse yellow 114 (DY 114). Yellow disperse dye colorant dispersions may include yellow disperse dyes, such as DY54, disperse yellow 64, disperse yellow 71, disperse yellow 86, DY114, disperse yellow 153, disperse yellow 233, disperse yellow 245, and mixtures thereof.

In these examples, the disperse dye colorant dispersion may include from about 10 wt % dye solids to about 20 wt % dye solids based on the total weight of the colorant dispersion. Also in these examples, the disperse dye colorant dispersion may include any of the dispersant(s) disclosed herein along with any example of the dispersion vehicle disclosed herein.

Examples of the dye sublimation inkjet ink that do not include the polymeric UV absorber also include one or more additives. Examples of suitable additives include a surfactant, a chelating agent, a buffer, an antimicrobial agent, and combinations thereof. Any of the surfactant(s), chelating agent(s), buffer(s), and/or antimicrobial agent(s) described herein may be used in these examples inks in any of the amounts described herein.

In addition to the disperse dye colorant dispersion and the additive(s), these examples of the dye sublimation inkjet ink also include a co-solvent. Any of the co-solvent(s) described herein may be used in these examples inks in any of the amounts described herein. It is to be understood that water is present in addition to the co-solvent(s) and makes up a balance of these example inks. As such, the weight percentage of the water present in the dye sublimation inkjet inks (that do not include the polymeric UV absorber) will depend, in part, upon the weight percentages of the other components. The water may be purified or deionized water.

Dye Sublimation Inkjet Ink Sets

The inks disclosed herein may be included in an ink set.

In an example, a dye sublimation inkjet ink set includes: (i) a first dye sublimation inkjet ink, which is an example of the ink disclosed herein that includes water soluble polymeric UV absorber having absorption at a radiation wavelength ranging from about 360 nm to about 410 nm; and (ii) a second dye sublimation inkjet ink, which is an example of the ink disclosed herein that includes a disperse dye having absorption at the radiation wavelength ranging from about 360 nm to about 410 nm (and thus does not include the water soluble polymeric UV absorber).

As a more specific example, a dye sublimation inkjet ink set, comprises: (i) a first dye sublimation inkjet ink including: a first disperse dye colorant dispersion; a water soluble polymeric UV absorber having absorption at a radiation wavelength ranging from about 360 nm to about 410 nm, a first co-solvent; and a balance of water; and (ii) a second dye sublimation inkjet ink including: a second disperse dye colorant dispersion including a disperse dye having absorption at the radiation wavelength ranging from about 360 nm to about 410 nm; a second co-solvent; and a balance of water. In one example of this ink set, the second dye sublimation inkjet ink does not include the water soluble polymeric UV absorber. In another example of this ink set, the water soluble polymeric UV absorber of the first dye sublimation inkjet ink includes a functionalized aromatic chromophore moiety; a polyether chain; and an amide linkage or an ether linkage attaching one end of the polyether chain to the functionalized aromatic chromophore moiety.

As still another more specific example, a dye sublimation inkjet ink set, comprises: (i) a first dye sublimation inkjet ink including: a first disperse dye colorant dispersion; a water soluble polymeric UV absorber having absorption at a radiation wavelength ranging from about 360 nm to about 410 nm, a first co-solvent; and a balance of water; and (ii) a second dye sublimation inkjet ink consisting of: a second disperse dye colorant dispersion; optionally, an additive selected from the group consisting of a surfactant, a chelating agent, a buffer, an antimicrobial agent, and combinations thereof; a second co-solvent; and a balance of water.

As still a more specific example, the dye sublimation inkjet ink set comprises (i) a first dye sublimation inkjet ink including: a first disperse dye colorant dispersion; a water soluble polymeric UV absorber having absorption at a radiation wavelength ranging from about 360 nm to about 410 nm, the water soluble polymeric UV absorber including: a functionalized aromatic chromophore moiety; a polyether chain; and an amide linkage or an ether linkage attaching one end of the polyether chain to the functionalized aromatic chromophore moiety; a first co-solvent; and a balance of water; and (ii) a second dye sublimation inkjet ink consisting of: a second disperse dye colorant dispersion; optionally, an additive selected from the group consisting of a surfactant, a chelating agent, a buffer, an antimicrobial agent, and combinations thereof; a second co-solvent; and a balance of water.

In these example ink sets, it is to be understood that any of the example inks with the water soluble polymeric UV absorber may be used as the first dye sublimation inkjet ink, and any of the example inks without the water soluble polymeric UV absorber may be used as the second dye sublimation inkjet ink. In one example, the first dye sublimation inkjet ink is a cyan dye sublimation inkjet ink or a magenta dye sublimation inkjet ink; and the second dye sublimation inkjet ink is a yellow dye sublimation inkjet ink or a black dye sublimation inkjet ink. In another example, the first dye sublimation inkjet ink is a cyan dye sublimation inkjet ink; the second dye sublimation inkjet ink is a yellow dye sublimation inkjet ink; and the ink set further includes a magenta dye sublimation inkjet ink (which includes the water soluble polymeric UV absorber) and a black dye sublimation inkjet ink (which does not include the water soluble polymeric UV absorber).

When the inks of these example ink sets are printed together, the radiation absorption across the different inks is relatively uniform, e.g., due to the water soluble polymeric UV absorber in some of the ink(s) (e.g., the first ink) and to the disperse dye in some other of the ink(s) (e.g., the second ink). As such, the radiation exposure may be the same for the entire print, regardless of the inks used to generate the print.

Substrates

In the examples disclosed herein, the ink(s) may be printed on any suitable substrate, including textile fabrics or polymeric films.

In an example, the textile fabric is selected from the group consisting of cotton fabrics, cotton blend fabrics, nylon fabrics, nylon blend fabrics, polyester fabrics, polyester blend fabrics, silk fabrics, silk blend fabrics, spandex, spandex blend fabrics, rayon, and rayon blend fabrics. In a further example, the textile fabric is selected from the group consisting of cotton fabrics and cotton blend fabrics. Blends may include the listed material in combination with one or more other material(s). An example of a tri-blend includes cotton, polyester and spandex. In one example disclosed herein, the textile fabric is selected from the group consisting of polyester fabrics and polyester blend fabrics.

It is to be understood that organic textile fabrics and/or inorganic textile fabrics may be used for the textile fabric. Some types of fabrics that can be used include various fabrics of natural and/or synthetic fibers.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric/substrate can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., KEVLAR®, E.I. du Pont de Nemours and Company) polytetrafluoroethylene (TEFLON®, The Chemours Co.), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

It is to be understood that the terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

Other suitable substrates include polymeric films. Examples of suitable polymeric film includes polyethylene terephthalate (PET) (e.g., solvoprint window-grip ultra clear from Neschen or WINCOS UV from Lintec), silicone (e.g., 3D Sublimation Printing Film SKU: R3D-G from Coastal Business Supplies), polyester films (e.g., HP Backlit Polyester), layered polyester and polypropylene (e.g., HP Everyday Blockout Display Film), polyester and/or PET imaging materials from FOLEX (e.g., FOLEX® PET SI262), resin coated PET (e.g., SO650 Solvent Backlit 200 Glossy from Natura), etc.

Printing Methods

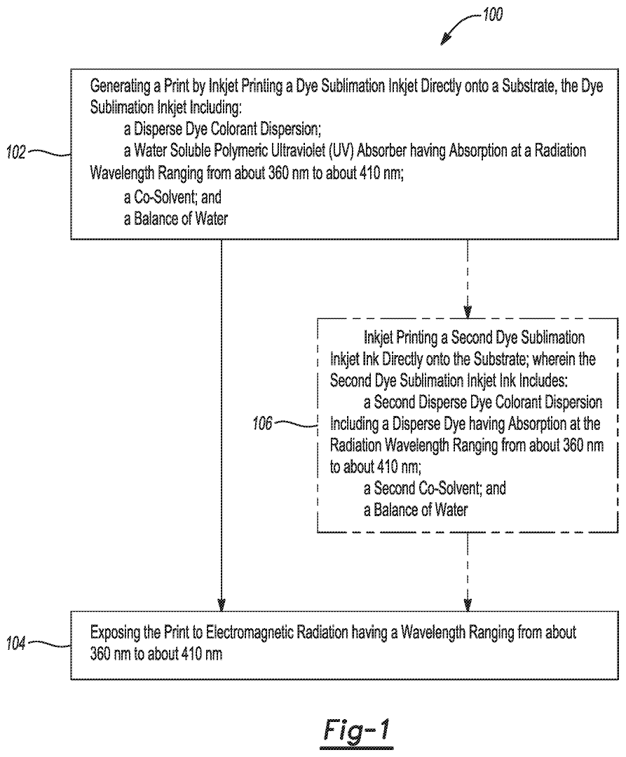

FIG. 1 depicts two examples of the printing method 100.

As shown in FIG. 1, one example of the printing method 100 comprises: generating a print by inkjet printing a dye sublimation inkjet ink directly onto a substrate, the dye sublimation inkjet ink including: a disperse dye colorant dispersion; a water soluble polymeric UV absorber having absorption at a radiation wavelength ranging from about 360 nm to about 410 nm; a co-solvent; and a balance of water (reference numeral 102); and exposing the print to electromagnetic radiation having a wavelength ranging from about 360 nm to about 410 nm (reference numeral 104). Any example of the dye sublimation inkjet ink which includes the water soluble polymeric UV absorber may be used in this example method. In one example, the water soluble polymeric UV absorber of the dye sublimation inkjet ink used in the printing method 100 includes: a functionalized aromatic chromophore moiety; a polyether chain; and an amide linkage or an ether linkage attaching one end of the polyether chain to the functionalized aromatic chromophore moiety; a first co-solvent; and a balance of water.

Also as shown in FIG. 1, another example of the printing method 100 comprises: generating a print by: inkjet printing a dye sublimation inkjet ink directly onto a substrate, the dye sublimation inkjet ink including: a disperse dye colorant dispersion; a water soluble polymeric UV absorber having absorption at a radiation wavelength ranging from about 360 nm to about 410 nm; a co-solvent; and a balance of water (reference numeral 102), and inkjet printing a second dye sublimation inkjet ink directly onto the substrate, wherein the second dye sublimation inkjet ink includes: a second disperse dye colorant dispersion including a disperse dye having absorption at the radiation wavelength ranging from about 360 nm to about 410 nm; a second co-solvent; and a balance of water (reference numeral 106); and exposing the print to electromagnetic radiation having a wavelength ranging from about 360 nm to about 410 nm (reference numeral 104). Any example of the dye sublimation inkjet ink which includes the water soluble polymeric UV absorber may be used as the dye sublimation inkjet ink in this example method, and any example of the dye sublimation inkjet ink which does not include the water soluble polymeric UV absorber may be used as the second dye sublimation inkjet ink in this example method.

The dye sublimation inkjet ink(s) may be inkjet printed onto the substrate (e.g., textile fabric, polymeric film, etc.) using any suitable inkjet applicator, such as a thermal inkjet printhead, a piezoelectric printhead, a continuous inkjet printhead, etc. The inkjet applicator may eject dye sublimation inkjet ink(s) in a single pass or in multiple passes. As an example of single pass printing, the cartridge(s) of an inkjet printer deposit the desired amount of the ink during the same pass of the cartridge(s) across the substrate. In other examples, the cartridge(s) of an inkjet printer deposit the desired amount of the ink composition over several passes of the cartridge(s) across the substrate.

In the examples of the method 100, the exposure of the print to electromagnetic radiation having a wavelength ranging from about 360 nm to about 410 nm may be accomplished with a radiation source. In an example, the radiation source may be a light emitting diode having an emission wavelength ranging from 360 nm to about 410 nm. In another example, the radiation source may be a narrow wavelength ultraviolet light source. In still another example of the method 100, the exposing of the print is accomplished with a narrow wavelength ultraviolet light source having an emission wavelength of 365 nm, 375 nm, 385 nm, 395 nm or 405 nm. In yet another example, the radiation source may be a 395 nm light emitting diode.

In the examples of the method 100, the exposure of the print to electromagnetic radiation having a wavelength ranging from about 360 nm to about 410 nm may take place for an amount of time sufficient to raise a temperature of the print so that the disperse dye(s) in the print is/are sublimated. In an example, the exposing of the print to the radiation wavelength may be for a time period ranging from about 0.1 seconds to about 20 seconds. In another example, the exposing of the print to the radiation wavelength may be for a time period ranging from about 0.1 seconds to about 5 seconds.

The radiation exposure takes place very rapidly with the radiation source. To avoid overheating, it may be desirable to adjust the settings of the radiation source. For example, either example of the method 100 may include setting the radiation source to a power setting ranging from about 3.5 W/cm² to about 10 W/cm². The power setting may depend, in part, upon the light source used, the total time for exposure, the distance between the light source and the substrate, etc. Higher power settings may be desirable for faster throughput systems. In another example, the energy (radiant) exposure ranges from about 0.5 J/cm² to about 20 J/cm². In a specific example, if a power of 10 W/cm² is applied for 1 second, the applied energy is 10 J/cm².

In one example, the exposing of the print to electromagnetic radiation is for a time period ranging from about 0.1 sec to about 5 sec; and the electromagnetic radiation results in an energy exposure ranging from about 0.5 J/cm² to about 20 J/cm².

The temperature at which sublimation takes place depends upon the disperse dye(s) that is/are used. In some examples, the radiation exposure may raise the temperature of the print to between about 150° C. and about 210° C., or between about 180° C. and about 220° C. It is to be understood that if the sublimation temperature of a selected ink were 200° C., the temperature to which the fabric (having the print thereon) is raised may be any suitable temperature at or slightly above (e.g., +5° C.) 200° C.

It is to be understood that the exposing of the print to the radiation wavelength may be accomplished using a single continuous pulse exposure of radiation, or a multiple pulsing mode of radiation exposure. As such, in some examples, the exposing of the print to electromagnetic radiation includes a single exposing event; and, in other examples, the exposing of the print to electromagnetic radiation includes multiple exposing events. Multiple exposing events including multiple radiation pulses, where the exposure time during each of the individual pulses of radiation may be added to calculate a total exposure time. Examples of this total exposure time fall within the example time period ranges disclosed above.

In some examples, both of the inks disclosed herein are used to generate a print. In these examples and when the printed-on substrate is exposed to the radiation wavelength ranging from about 360 nm to about 410 nm, the water soluble polymeric UV absorber of at least one of the inks and the disperse dye of at least another of the inks absorbs the energy. The polymeric UV absorber of the first ink will absorb the applied radiation, and transfer the energy to the dye as heat. The presence of the UV absorber may rapidly bring the dye to its sublimation temperature. The disperse dye of the second ink itself is capable of absorbing the applied radiation, which heats the dye up to its sublimation temperature. Energy absorption and subsequent heating causes the dyes to sublimate and migrate into the substrate material (e.g., fibers of the textile fabric). The dyes then re-solidify on the substrate, which renders the printed image durable and in some instances wash-resistant and colorfast.

To further illustrate the present disclosure, an example is given herein. It is to be understood that this example is provided for illustrative purposes and is not to be construed as limiting the scope of the present disclosure.

This example illustrates that the addition of the water soluble polymeric UV absorber to an ink with a low absorbing disperse dye improves the absorption of the ink, and enables it to be sublimated using a rapid energy exposure technique. Moreover, the generated prints have a desirable optical density and washfastness. “Washfastness,” as used herein, refers to the ability of a print on a fabric to retain its color after being exposed to washing. Washfastness can be measured in terms of ΔE. The term “ΔE,” as used herein, refers to the change in the L*a*b* values of a color (e.g., cyan, magenta, yellow, black, red, green, blue, white) after washing. ΔE can be calculated by different equations, such as the CIEDE1976 color-difference formula and the CIEDE2000 color-difference formula.

### Example

In this example, a comparative magenta ink (Comp. M Ink) was prepared along with two example magenta inks (Ex. M Ink1 and Ex. M Ink2) and one yellow example ink (Ex. Y Ink). The ink compositions are shown in Table 1, with the values representing wt % actives.

TABLE 1

| | | | Comp | | |
|---|---|---|---|---|---|
| Ink | | Ex. | M | Ex. M | Ex. M |
| Component | Specific Component | Y ink | Ink | Ink1 | Ink2 |
| Dye | Yellow Dispersion | 3.7 | 0 | 0 | 0 |
| Dispersion | Magenta Dispersion | 0 | 5 | 5 | 5 |
| Polymeric UV Absorber | 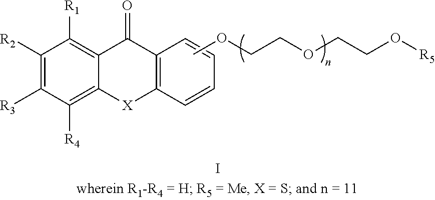 | 0 | 0 | 2 | 4 |
| Co-solvents | Glycerol | 12 | 12 | 12 | 12 |
| | Ethoxylated Glycerol | 4 | 4 | 4 | 4 |
| Surfactant | SURFYNOL ® 465 | 0.5 | 0.5 | 0.5 | 0.5 |
| Jetting Aid | Oleth-3-Phosphate | 0 | 0.2 | 0.2 | 0.2 |
| (surfactant) | | | | | |
| Chelating | TRILON ® M | 0.04 | 0.04 | 0.04 | 0.04 |
| Agent | | | | | |
| Buffer | TRIS | 0.1 | 0.1 | 0.1 | 0.1 |
| Biocide | ACTICIDE ® B20 | 0.0045 | 0.0045 | 0.0045 | 0.0045 |
| | ACTICIDE ® M20 | 0.0095 | 0.0095 | 0.0095 | 0.0095 |
| Deionized | | Bal. | Bal. | Bal. | Bal. |
| Water | | | | | |

Several prints were generated by thermal inkjet printing using the example ink compositions and the comparative magenta ink composition. For each print, the amount of the ink composition printed was 20 gsm. The prints were generated on polyester fabric. No pre-treatment was performed on the fabric before generating the prints.

A 395 nm light emitting diode (Hereaus lamp) was used to perform dye sublimation on the different print samples. When operated at 50% power, the UV energy exposure was 6.62 J/cm². These samples were exposed to radiation for 1 second. When operated at 70% power, the UV energy exposure was 9.23 J/cm². These samples were exposed for 700 milliseconds.

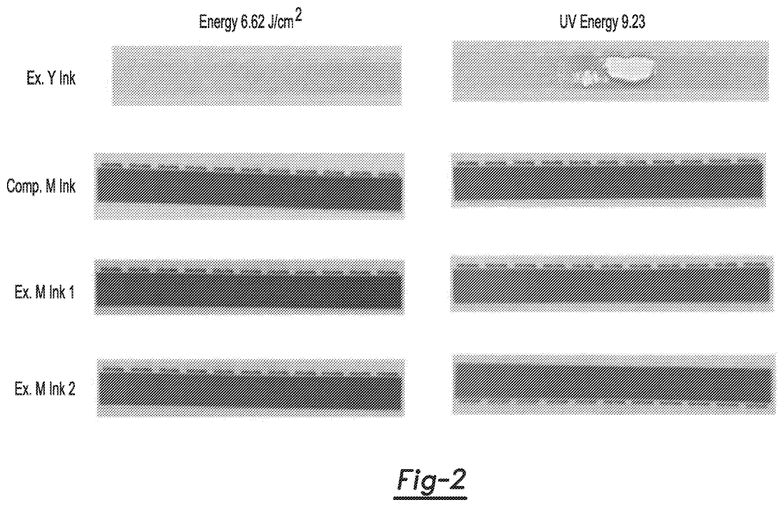

Color photographs of each of the prints were taken after energy exposure. The photographs are reproduced in black and white in FIG. 2. The photographs on the left illustrate the prints that were sublimated with energy exposure of 6.62 J/cm², and the photographs on the right illustrate the prints that were sublimated with energy exposure of 9.23 J/cm². The pictures illustrate that the yellow ink (Ex. Y Ink) absorbed enough energy for dye sublimation without the addition of the polymeric UV absorber, and that the higher energy level may be too much for this particular ink. When comparing the pictures of the comparative magenta ink (Comp. M Ink, which had no polymeric UV absorber), with the example magenta inks (Ex. M Ink1 and Ex. M Ink2, which had different amounts of the polymeric UV absorber), the pictures clearly illustrate that the example magenta inks benefit from the addition of the polymeric UV absorber. In particular, Ex. M Ink1 and Ex. M Ink2 exhibited more uniform color.

Optical Density

The initial optical density (initial OD) of each of the prints was measured. Then, the prints were washed 5 times in a Kenmore 90 Series Washer (Model 110.289 227 91) with warm water (at about 40° C.) and detergent. Each print was allowed to air dry between each wash. Then, the optical density (OD after 5 washes) of each print was measured, and the percent change in optical density (%Δ OD) was calculated for each print.

The initial optical density (initial OD), the optical density after 5 washes (OD after 5 washes), and the percent change in optical density (%Δ in OD) of each region and print are shown in Table 2. In Table 2, each print is identified by the example ink composition.

TABLE 2

| Ink composi- | UV Energy Exposure | | | UV Energy Exposure | | |
|---|---|---|---|---|---|---|
| tion used to | 6.62 J/cm² | | | 9.23 J/cm² | | |
| generate | Initial | OD after | Δ OD | Initial | OD after | Δ OD |
| the print | OD | 5 washes | (%) | OD | 5 washes | (%) |
| Ex. Y Ink | 1.584 | 1.573 | −0.69 | 1.595 | 1.534 | −3.82% |
| Comp. M Ink | 1.232 | 1.071 | −13.07 | 1.417 | 1.353 | −4.52% |
| Ex. M Ink1 | 1.344 | 1.264 | −5.95 | 1.429 | 1.337 | −6.44% |
| Ex. M Ink2 | 1.354 | 1.274 | −5.91 | 1.485 | 1.429 | −3.77% |

As shown in Table 2, the example yellow ink exhibited desirable optical density both before and after washing at the lower energy exposure. The change in optical density for both of the example magenta inks was significantly improved when compared to the comparative magenta ink at the lower energy exposure. The change in optical density for Ex. M Ink2 (with a higher amount of UV absorber) was significantly improved when compared to the comparative magenta ink at the higher energy exposure.

Moreover, the example magenta inks also exhibited an increase in optical density when compared to the comparative magenta ink. The initial optical density of Ex. M Ink1 was 9% greater than the initial optical density of Comp. M Ink; and the optical density after 5 washes of Ex. M Ink1 was 18% greater than the optical density after 5 washes of Comp. M Ink. Similarly, the initial optical density of Ex. M Ink2 was 10% greater than the initial optical density of Comp. M Ink; and the optical density after 5 washes of Ex. M Ink2 was 19% greater than the optical density after 5 washes of Comp. M Ink.

Washfastness

The prints sublimated with energy exposure of 6.62 J/cm² were also tested for washfastness. The L*a*b* values of a color (e.g., cyan, magenta, yellow, black, red, green, blue, white) before and after the 5 washes were measured. L* is lightness, a* is the color channel for color opponents green-red, and b* is the color channel for color opponents blue-yellow. The color change was then calculated using the CIEDE2000 color-difference formula.

The CIEDE2000 color-difference formula is based on the CIELAB color space. Given a pair of color values in CIELAB space L*₁,a*₁,b*₁ and L*₂,a*₂,b*₂, the CIEDE2000 color difference between them is as follows:

ΔE₀₀(L₁*,a₁*,b₁*;L₂*;L₂*,a₂*,b₂*)=ΔE₀₀¹²=ΔE₀₀ (1)

It is noted that ΔE₀₀ is the commonly accepted notation for CIEDE2000.

Given two CIELAB color values {Lᵢ*,aᵢ*,bᵢ*}ᵢ₌₁² and parametric weighting factors k_{L},k_{C},k_{H}, the process of computation of the color difference is summarized in the following equations, grouped as three main parts.

1. Calculate C′ᵢ, h′ᵢ:

$$\begin{matrix}{C}_{i , ab}^{*} = \sqrt{( {( {a}_{i}^{*} )}^{2} + {( {b}_{i}^{*} )}^{2} )} , i = 1 , 2 & ( 2 ) \\ {\overline{C}}_{a b}^{*} = \frac{{C}_{1 , ab}^{*} + {C}_{2 , ab}^{*}}{2} & ( 3 ) \\ G = 0.5 ( 1 - \sqrt{( \frac{{\overline{C}}_{a b}^{* 7}}{{\overline{C}}_{a b}^{* 7} + 2 {5}^{7}} )} ) & ( 4 ) \\ {a}_{i}^{′} = ( 1 + G ) {a}_{i}^{*} , i = 1 , 2 & ( 5 ) \\ {C}_{i}^{′} = \sqrt{( {( {a}_{i}^{′} )}^{2} + {( {b}_{i}^{′} )}^{2} )} , i = 1 , 2 & ( 6 ) \\ {h}_{i}^{′} = \{ \begin{matrix}0 & {b}_{i}^{*} = {a}_{i}^{′} = 0 \\ {tan}^{- 1} ( {b}_{i}^{*} , {a}_{i}^{′} ) & otherwise\end{matrix} , i = 1 , 2 & ( 7 )\end{matrix}$$

2. Calculate ΔL′, ΔC′, ΔH′:

$$\begin{matrix}Δ {L}^{′} = {L}_{2}^{*} - {L}_{1}^{*} & ( 8 ) \\ Δ {C}^{′} = {C}_{2}^{*} - {C}_{1}^{*} & ( 9 ) \\ Δ {h}^{′} = \{ \begin{matrix}0 & {C}_{1}^{′} {C}_{2}^{′} = 0 \\ {h}_{2}^{′} - {h}_{1}^{′} & {C}_{1}^{′} {C}_{2}^{′} \neq 0 ; \vert {h}_{2}^{′} - {h}_{1}^{′} \vert \leq 180 ° \\ ( {h}_{2}^{′} - {h}_{1}^{′} ) - 360 & {C}_{1}^{′} {C}_{2}^{′} \neq 0 ; ( {h}_{2}^{′} - {h}_{1}^{′} ) > 180 ° \\ ( {h}_{2}^{′} - {h}_{1}^{′} ) + 360 & {C}_{1}^{′} {C}_{2}^{′} \neq 0 ; ( {h}_{2}^{′} - {h}_{1}^{′} ) < - 180 °\end{matrix} & ( 10 ) \\ Δ {H}^{′} = 2 \sqrt{{C}_{1}^{′} {C}_{2}^{′}} sin ( \frac{Δ {h}^{′}}{2} ) & ( 11 )\end{matrix}$$

3. Calculate CIEDE2000 color-difference ΔE₀₀:

$$\begin{matrix} {\overline{L}}^{′} = ( {L}_{1}^{*} + {L}_{2}^{*} ) \text{/} 2 & ( 12 ) \\ {\overline{C}}^{′} = ( {C}_{1}^{′} + {C}_{2}^{′} ) \text{/} 2 & ( 13 ) \\ {\overline{h}}^{′} = \{ \begin{matrix}\frac{{h}_{1}^{′} + {h}_{2}^{′}}{2} & \vert {h}_{1}^{′} - {h}_{2}^{′} \vert \leq 180 ° ; {C}_{1}^{′} {C}_{2}^{′} \neq 0 \\ \frac{{h}_{1}^{′} + {h}_{2}^{′} + 360 °}{2} & \vert {h}_{1}^{′} - {h}_{2}^{′} \vert > 180 ° ; ( {h}_{1}^{′} + {h}_{2}^{′} ) < 360 ° ; {C}_{1}^{′} {C}_{2}^{′} \neq 0 \\ \frac{{h}_{1}^{′} + {h}_{2}^{′} - 360 °}{2} & \vert {h}_{1}^{′} - {h}_{2}^{′} \vert > 180 ° ; ( {h}_{1}^{′} + {h}_{2}^{′} ) \geq 360 ° ; {C}_{1}^{′} {C}_{2}^{′} \neq 0 \\ ( {h}_{1}^{′} + {h}_{2}^{′} ) & {C}_{1}^{′} {C}_{2}^{′} = 0\end{matrix} & ( 14 ) \\ T = 1 - 0.17 cos ( {\overline{h}}^{′} - 30 ° ) + 0.24 cos ( 2 {\overline{h}}^{′} ) + 0.32 cos ( 3 {\overline{h}}^{′} + 6 ° ) - 0.20 cos ( 4 {\overline{h}}^{′} - 63 ° ) & ( 15 ) \\ Δθ = 30 exp \{ - {[ \frac{{\overline{h}}^{′} - 275 °}{25} ]}^{2} \} & ( 16 ) \\ {R}_{c} = 2 \sqrt{( \frac{{\overline{C}}^{′7} }{{\overline{C}}^{′7} + 2 {5}^{7}} )} & ( 17 ) \\ {S}_{L} = 1 + \frac{0015 {( {\overline{L}}^{′} - 50 )}^{2}}{\sqrt{( 20 + {( {\overline{L}}^{′} - 50 )}^{2} )}} & ( 18 ) \\ {S}_{C} = 1 + 0 .045 {\overline{C}}^{′} & ( 19 ) \\ {S}_{H} = 1 + 0.0 \; 15 {\overline{C}}^{′} T & ( 20 ) \\ {R}_{T} = - sin ( 2 Δ θ ) {R}_{C} & ( 21 ) \\ Δ {E}_{00}^{12} = Δ {E}_{00} ( {L}_{1}^{*} , {a}_{1}^{*} , {b}_{1}^{*} ; {L}_{2}^{*} ; {L}_{2}^{*} , {a}_{2}^{*} , {b}_{2}^{*} ) = \sqrt{( \begin{matrix}\begin{matrix}{( \frac{Δ {L}^{′}}{{k}_{L} {S}_{L}} )}^{2} + \\ {( \frac{Δ {C}^{′}}{{k}_{C} {S}_{C}} )}^{2} +\end{matrix} \\ \begin{matrix}{( \frac{Δ {H}^{′}}{{k}_{H} {S}_{H}} )}^{2} + \\ {R}_{T} ( \frac{Δ {C}^{′}}{{k}_{C} {S}_{C}} ) ( \frac{Δ {H}^{′}}{{k}_{H} {S}_{H}} )\end{matrix}\end{matrix} )} & ( 22 )\end{matrix}$$

The results of the ΔE₀₀ calculations (washfastness, ΔE) for each print is shown in Table 3. In Table 3, each print is identified by the example ink composition.

TABLE 3

| | UV Energy | UV Energy |
|---|---|---|
| | Exposure | Exposure |
| Ink composition used | 6.62 J/cm² | 9.23 J/cm² |
| to generate the print | ΔE | ΔE |
| Ex. Y Ink | 1.0 | 2.5 |
| Comp. M Ink | 9.1 | 4.9 |
| Ex. M Ink1 | 5.4 | 5.0 |
| Ex. M Ink2 | 6.3 | 2.8 |

As illustrated in Table 3, the washfastness of the prints formed with example magenta inks and sublimated with energy exposure of 6.62 J/cm² was improved relative to the print formed with the comparative magenta ink. Also as illustrated in Table 3, the washfastness of the prints formed with example magenta inks and sublimated with energy exposure of 9.23 J/cm² was comparable to or improved relative to the print formed with the comparative magenta ink.

It is to be understood that the ranges provided herein include the stated range and any value or sub-range within the stated range, as if such values or sub-ranges were explicitly recited. For example, from about 360 nm to about 410 nm should be interpreted to include not only the explicitly recited limits of from about 360 nm to about 410 nm, but also to include individual values, such as about 368.5 nm, about 379.75 nm, about 384.67 nm, about 397.0 nm, about 405.2 nm, etc., and sub-ranges, such as from about 366.53 nm to about 382.5 nm, from about 380.25 nm to about 396.2 nm, from about 391.75 nm to about 408.79 nm, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A dye sublimation inkjet ink, comprising:
a disperse dye colorant dispersion;
a water soluble polymeric ultraviolet (UV) absorber having absorption at a radiation wavelength ranging from about 360 nm to about 410 nm;
a co-solvent; and
a balance of water.

2. The dye sublimation inkjet ink as defined in claim 1 wherein the disperse dye colorant dispersion is a cyan disperse dye colorant dispersion or a magenta disperse dye colorant dispersion.

3. The dye sublimation inkjet ink as defined in claim 1 wherein the water soluble polymeric UV absorber includes:
a functionalized aromatic chromophore moiety;
a polyether chain; and
an amide linkage or an ether linkage attaching one end of the polyether chain to the functionalized aromatic chromophore moiety;

4. The dye sublimation inkjet ink as defined in claim 3 wherein the functionalized aromatic chromophore moiety of the water soluble polymeric UV absorber includes 3 to 4 conjugate rings and is selected from the group consisting of an anthrone moiety, an anthracene moiety, a phenanthrene moiety, a chrysene moiety, a pyrene moiety, a perylene moiety, a triphenylene moiety, a xanthene moiety, a cyanine moiety, a merocyanine moiety, an acridone moiety, an acridine moiety, an anthraquinone moiety, and a coumarin moiety.

5. The dye sublimation inkjet ink as defined in claim 3, further comprising an additional functionalized aromatic chromophore moiety attached to an opposed end of the polyether chain through an additional ether linkage or an additional amide linkage.

6. The dye sublimation inkjet ink as defined in claim 1 wherein the water soluble polymeric UV absorber has a formula (I) of: 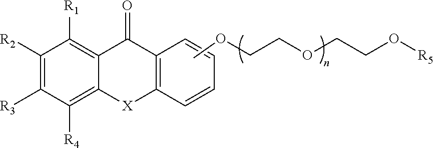
and wherein:
R₁, R₂, R₃, R₄, and R₅ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group;
R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group;
X is O, S, or NH; and
n ranges from 1 to 200.

7. The dye sublimation inkjet ink as defined in claim 1 wherein the water soluble polymeric UV absorber has a formula (II) of: 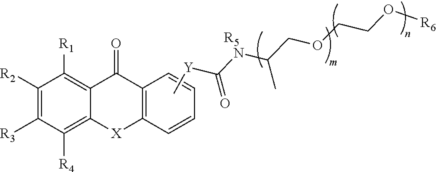
and wherein:
R₂, R₃, R₄, R₅, and R₆ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, —NR_{d}—CO—NRₑR_{f}, —SR_{d}, —SO—R_{d}, —SO₂—R_{d}, —SO₂—O—R_{d}, —SO₂NR_{d}Rₑ and a perfluoroalkyl group;
R_{d}, Rₑ, and R_{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group;
Y is a bond, (CH₂)_{q}, or O(CH₂)_{q}, wherein q is any integer from 1 to 100;
X is O, S, or NH;
m ranges from 1 to 200; and
n ranges from 1 to 200.

8. The dye sublimation inkjet ink as defined in claim 1 wherein the water soluble polymeric UV absorber is present in an amount ranging from about 0.1 wt % to about 20 wt % based on a total weight of the dye sublimation inkjet ink.

9. A dye sublimation inkjet ink set, comprising:
(i) a first dye sublimation inkjet ink including:
a first disperse dye colorant dispersion;
a water soluble polymeric UV absorber having absorption at a radiation wavelength ranging from about 360 nm to about 410 nm;
a first co-solvent; and
a balance of water; and
(ii) a second dye sublimation inkjet ink including:
a second disperse dye colorant dispersion including a disperse dye having absorption at the radiation wavelength ranging from about 360 nm to about 410 nm;
a second co-solvent; and
a balance of water.

10. The dye sublimation inkjet ink set as defined in claim 9 wherein:
the first dye sublimation inkjet ink is a cyan dye sublimation inkjet ink or a magenta dye sublimation inkjet ink; and
the second dye sublimation inkjet ink is a yellow dye sublimation inkjet ink or a black dye sublimation inkjet ink.

11. The dye sublimation inkjet ink set as defined in claim 9 wherein the water soluble polymeric UV absorber includes:
a functionalized aromatic chromophore moiety;
a polyether chain; and
an amide linkage or an ether linkage attaching one end of the polyether chain to the functionalized aromatic chromophore moiety.

12. A printing method, comprising:
generating a print by inkjet printing a dye sublimation inkjet ink directly onto a substrate, the dye sublimation inkjet ink including:
a disperse dye colorant dispersion;
a water soluble polymeric UV absorber having absorption at a radiation wavelength ranging from about 360 nm to about 410 nm; and
a balance of water; and
exposing the print to electromagnetic radiation having a wavelength ranging from about 360 nm to about 410 nm.

13. The printing method as defined in claim 12 wherein:
the generating of the print further includes inkjet printing a second dye sublimation inkjet ink directly onto the substrate; and
the second dye sublimation inkjet ink includes:
a second disperse dye colorant dispersion including a disperse dye having absorption at the radiation wavelength ranging from about 360 nm to about 410 nm;
a second co-solvent; and
a balance of water.

14. The printing method as defined in claim 12 wherein:
the exposing of the print to electromagnetic radiation is for a time period ranging from about 0.1 sec to about 5 sec; and
the electromagnetic radiation results in an energy exposure ranging from about 0.5 J/cm² to about 20 J/cm².

15. The printing methods as defined in claim 12 wherein the water soluble polymeric UV absorber includes:
a functionalized aromatic chromophore moiety;
a polyether chain; and
an amide linkage or an ether linkage attaching one end of the polyether chain to the functionalized aromatic chromophore moiety.
